(19) United States
(12) Patent Application Publication
(10) Pub. No.: US 2026/0127845 A1
(43) Pub. Date: May 7, 2026

(54) INFORMATION PROCESSING DEVICE, INFORMATION PROCESSING SYSTEM, AND OUTPUT METHOD

(71) Applicant: Mitsubishi Electric Corporation, TOKYO (JP)

(72) Inventor: Takafumi KOIKE, Tokyo (JP)

(73) Assignee: Mitsubishi Electric Corporation, TOKYO (JP)

(21) Appl. No.: 19/436,321

(22) Filed: Dec. 30, 2025

Related U.S. Application Data
(63) Continuation of application No. PCT/JP2023/024901, filed on Jul. 5, 2023.

(51) Int. Cl. G06V 10/56; G06N 5/04; G06T 11/10; G06V 10/25; G06V 10/44; G06V 10/70; G06V 40/10

(52) U.S. Cl. CPC G06V 10/56; G06T 11/10; G06V 10/25; G06V 10/44; G06V 10/70; G06N 5/04; G06V 40/107

(57) ABSTRACT

An information processing device includes an acquisition unit that acquires an inference object image and a learned model, an inference unit that makes an inference by using the inference object image and the learned model, a generation unit that generates a heat map by using an inference result, an extraction unit that extracts a plurality of features based on the heat map, and an output unit. The generation unit generates a plurality of modification images by making a modification in regard to each of the features by using the inference object image. The inference unit makes the inference by using the modification images and the learned model. The generation unit generates heat maps by using a plurality of inference results. The output unit outputs the modification images and the heat maps, or inference basis information.

### CROSS-REFERENCE TO RELATED APPLICATION

This application is a continuation application of International Application No. PCT/JP2023/024901 having an international filing date of Jul. 5, 2023, which is hereby expressly incorporated by reference into the present application.

### BACKGROUND OF THE INVENTION

### 1. Field of the Invention

The present disclosure relates to an information processing device, an information processing system, and an output method.

### 2. Description of the Related Art

Learned models are used in recent years. The learned model is formed in complex structure. Accordingly, there is a problem in that an inference result of the learned model cannot be used without worry. In such a circumstance, Explainable Artificial Intelligence (XAI) is known as a technology for outputting an inference basis. A technology regarding the XAI has been proposed (see Patent Reference 1). An image output device in the Patent Reference 1 generates a heat map indicating the basis of the inference result by using the XAI.

Patent Reference 1: Japanese Patent Application Publication No. 2022-96379

In the above-described technology, the heat map is generated. However, there are cases where a user cannot understand a detailed inference basis even by viewing the heat map.

### SUMMARY OF THE INVENTION

An object of the present disclosure is to output data that enable the user to understand the inference basis.

An information processing device according to an aspect of the present disclosure is provided. The information processing device includes an acquisition unit that acquires an inference object image and a learned model, an inference unit that makes an inference by using the inference object image and the learned model, a generation unit that generates a heat map that indicates a basis of an inference result by using the inference result, an extraction unit that extracts a plurality of features based on a region in the inference object image, the region being a region corresponding to a part as the basis of the inference result indicated by the heat map, and an output unit. When the plurality of features has been extracted, the generation unit generates a plurality of modification images by making a modification in regard to each of the features by using the inference object image. When the plurality of modification images has been generated, the inference unit makes the inference by using the plurality of modification images and the learned model. When the inference has been made by using the plurality of modification images and the learned model, the generation unit generates a plurality of heat maps by using a plurality of inference results. The output unit outputs the plurality of modification images and the plurality of heat maps, or inference basis information generated based on the inference object image, the heat map, the plurality of modification images and the plurality of heat maps.

According to the present disclosure, data that enable the user to understand the inference basis can be outputted.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in an information processing device in a first embodiment;

FIG. 2 is a block diagram showing functions of the information processing device in the first embodiment;

FIG. 3 is a diagram showing a concrete example of an inference object image and a heat map in the first embodiment;

FIG. 4 is a diagram showing an example of a generation process in the first embodiment;

FIG. 5 is a diagram showing a concrete example of output information in the first embodiment;

FIG. 6 is a flowchart showing an example of a process executed by the information processing device in the first embodiment;

FIG. 7 is a block diagram showing functions of an information processing device in a second embodiment;

FIG. 8 is a diagram showing a concrete example of a generation process in the second embodiment;

FIG. 9 is a flowchart showing an example of a process executed by the information processing device in the second embodiment;

FIG. 10 is a diagram showing a concrete example of a generation process in a first modification of the second embodiment;

FIG. 11 is a diagram showing a concrete example of a generation process in a second modification of the second embodiment; and

FIG. 12 is a diagram showing an information processing system in a third embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

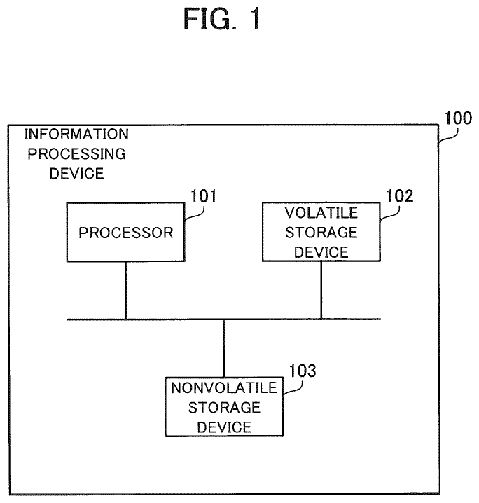

FIG. 1 is a diagram showing hardware included in an information processing device in a first embodiment. The information processing device 100 is a computer. The information processing device 100 is a device that executes an output method. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions included in the information processing device 100 will be described below.

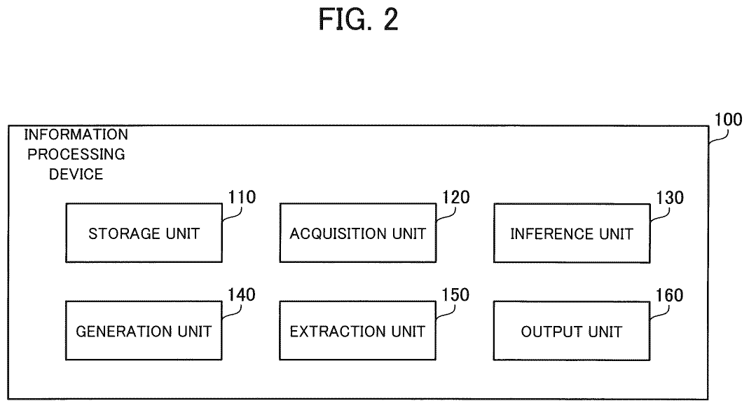

FIG. 2 is a block diagram showing the functions of the information processing device in the first embodiment. The information processing device 100 includes a storage unit 110, an acquisition unit 120, an inference unit 130, a generation unit 140, an extraction unit 150 and an output unit 160.

The storage unit 110 may be implemented as a storage area reserved in the volatile storage device 102 or the nonvolatile storage device 103.

Part or all of the acquisition unit 120, the inference unit 130, the generation unit 140, the extraction unit 150 and the output unit 160 may be implemented by processing circuitry. Further, part or all of the acquisition unit 120, the inference unit 130, the generation unit 140, the extraction unit 150 and the output unit 160 may be implemented as modules of a program executed by the processor 101. For example, the program executed by the processor 101 is referred to also as an output program. The output program has been recorded in a record medium, for example.

The storage unit 110 stores a variety of information.

The acquisition unit 120 acquires an inference object image. For example, the acquisition unit 120 acquires the inference object image from the storage unit 110. Further, for example, the acquisition unit 120 acquires the inference object image from an external device. The external device is a cloud server, for example. Incidentally, illustration of the external device is left out. Furthermore, for example, the acquisition unit 120 acquires the inference object image obtained by a user's input operation. Incidentally, the inference object image is an image of an inference object.

The acquisition unit 120 acquires a learned model. For example, the acquisition unit 120 acquires the learned model from the storage unit 110 or the external device.

The inference unit 130 makes an inference by using the inference object image and the learned model. Specifically, when the inference unit 130 inputs the inference object image to the learned model, the learned model outputs an inference result.

The generation unit 140 generates a heat map that indicates a basis of the inference result by using the inference result. Specifically, the generation unit 140 generates the heat map by using the inference result and XAI. For example, the generation unit 140 generates the heat map by using Gradient weighted Class Activation Mapping (Grad-CAM). Here, a concrete example of the inference object image and the generated heat map will be shown below.

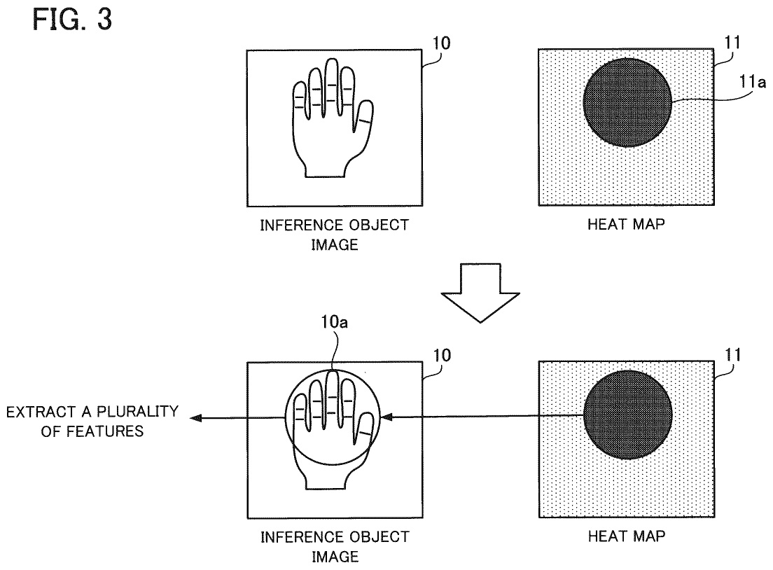

FIG. 3 is a diagram showing a concrete example of the inference object image and the heat map in the first embodiment. FIG. 3 shows an inference object image 10 and a heat map 11. Further, a range 11a indicates a part as the basis of the inference result.

The extraction unit 150 extracts a plurality of features based on a region 10a in the inference object image 10, which corresponds the part as the basis of the inference result. For example, the extraction unit 150 extracts a pale orange color based on the region 10a. The extraction unit 150 extracts a gray color as the color of a peripheral part in the region 10a. In other words, the extraction unit 150 extracts a gray color as the color of a part (i.e., background) in the region 10a other than fingers. The extraction unit 150 extracts lightness of a hand part being 75% based on the region 10a. The extraction unit 150 extracts the lightness of the peripheral part in the region 10a being 50%. The extraction unit 150 extracts a high-frequency component based on the region 10a. Incidentally, the high-frequency component is a thin line such as a wrinkle, for example. The extraction unit 150 extracts a low-frequency component based on the region 10a. Incidentally, the low-frequency component is a thick line such as a finger or a hand, for example.

Further, the feature can be a mid-frequency component, for example. Incidentally, the extraction unit 150 is capable of extracting the high-frequency component, the mid-frequency component and the low-frequency component by using multiresolution analysis. As above, the extraction unit 150 may extract frequency components as features based on the region 10a.

Furthermore, the feature can be a line, a shape, a particular shape or the like, for example. The shape is a circle, for example. The particular shape is the shape of a finger, the shape of a hand, or the like, for example. Incidentally, the extraction unit 150 is capable of extracting a line, a shape, a particular shape or the like by using a learned model, image analysis technology, or the like.

When a plurality of features has been extracted, the generation unit 140 generates a plurality of modification images by making a modification in regard to each of the features by using the inference object image. Incidentally, the modification image is an image in which the feature has been modified or eliminated. The generation process will be described below by using a drawing.

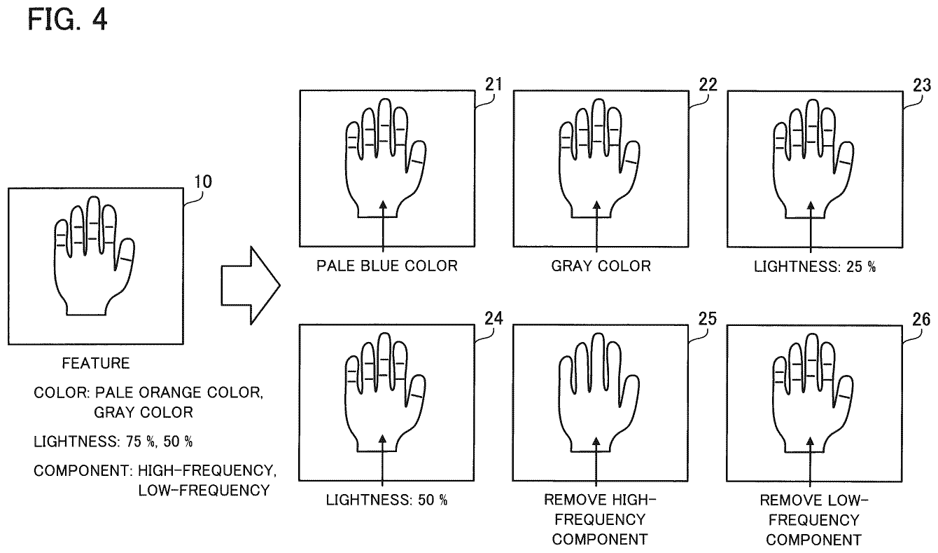

FIG. 4 is a diagram showing an example of the generation process in the first embodiment.

The generation unit 140 generates an image in a color opposite in the hue to the color as the feature by using the inference object image 10. Specifically, the generation unit 140 generates a modification image 21 in which a pale orange color (i.e., the color of a hand) has been modified to a pale blue color. By this, the modification image 21 including the hand in the pale blue color is generated. Incidentally, the information processing device 100 is capable of eliminating influence of the feature by generating an image in the opposite color.

The generation unit 140 generates an image in the same color as the color of the peripheral part in the region 10a by using the inference object image 10. Specifically, the generation unit 140 generates a modification image 22 in the same color as the color of the peripheral part in the region 10a (i.e., gray color). By this, the modification image 22 including the hand in the gray color is generated. Incidentally, as will be described later, the information processing device 100 is capable of checking whether the color of the peripheral part in the region 10a is the inference basis or not by generating the modification image 22.

The generation unit 140 generates an image with lightness opposite to the lightness as the feature by using the inference object image 10. Specifically, the generation unit 140 generates a modification image 23 with lightness (25%=100-75) opposite to the lightness as the feature (i.e., 75%). By this, the modification image 23 in which the lightness of the hand is 25% is generated. Incidentally, the information processing device 100 is capable of eliminating the influence of the feature by generating an image with the opposite lightness.

The generation unit 140 generates an image with lightness the same as the lightness of the peripheral part in the region 10a by using the inference object image 10. Specifically, the generation unit 140 generates a modification image 24 with lightness the same as the lightness of the peripheral part in the region 10a (i.e., 50%). By this, the modification image 24 in which the lightness of the hand is 50% is generated. Incidentally, as will be described later, the information processing device 100 is capable of checking whether the lightness of the peripheral part in the region 10a is the inference basis or not by generating the modification image 24.

The generation unit 140 generates a modification image 25 in which the high-frequency component as the feature has been removed by using the inference object image 10.

The generation unit 140 generates a modification image 26 in which the low-frequency component as the feature has been removed by using the inference object image 10.

Here, the removal includes a meaning of weakening the frequency component. As will be described later, the modification image is inputted to the learned model. If the learned model does not read out a frequency component, the frequency component does not need to be removed. Therefore, the generation unit 140 may generate a modification image in which a frequency component has been weakened.

The inference unit 130 makes the inference by using the plurality of modification images and the learned model. Specifically, when the inference unit 130 inputs the plurality of modification images respectively to the learned model, the learned model outputs a plurality of inference results.

The generation unit 140 generates a plurality of heat maps by using the plurality of inference results. Specifically, the generation unit 140 generates the plurality of heat maps by using the plurality of inference results and the XAI.

The output unit 160 outputs the inference object image 10, the heat map 11, the plurality of modification images, and the plurality of heat maps. For example, the output unit 160 outputs the inference object image 10 and the other data to a display of the information processing device 100. Alternatively, for example, the output unit 160 outputs the inference object image 10 and the other data to the external device.

Here, an example of the inference object image 10, the heat map 11, the plurality of modification images, and the plurality of heat maps will be shown below.

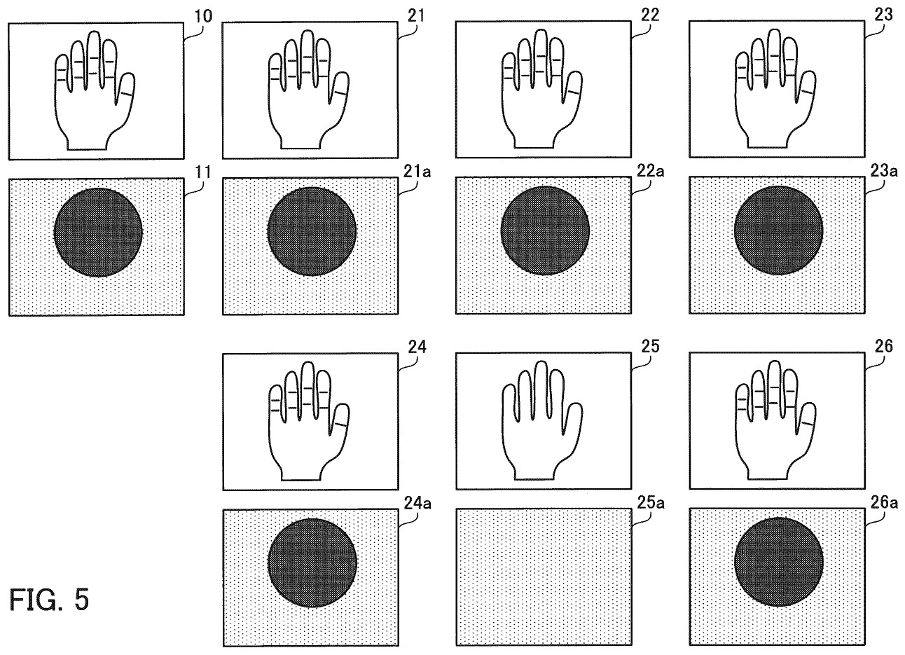

FIG. 5 is a diagram showing a concrete example of output information in the first embodiment. FIG. 5 shows the inference object image 10, the heat map 11, the modification images 21 to 26, and heat maps 21a to 26a.

For example, the user can analyze that the high-frequency component (i.e., wrinkle) is the inference basis by viewing the output information displayed on the display. Specifically, among the heat maps 21a to 26a, only the heat map 25a shows no part as the basis of the inference result. In the modification image 25, the high-frequency component was removed. Therefore, the heat map 25a shows no part as the basis of the inference result. In other words, the heat maps 21a to 24a and 26a show the part as the basis of the inference result since the high-frequency component is included in the modification images 21 to 24 and 26. Therefore, the user can analyze that the high-frequency component is the inference basis.

Next, a process executed by the information processing device 100 will be described below by using a flowchart.

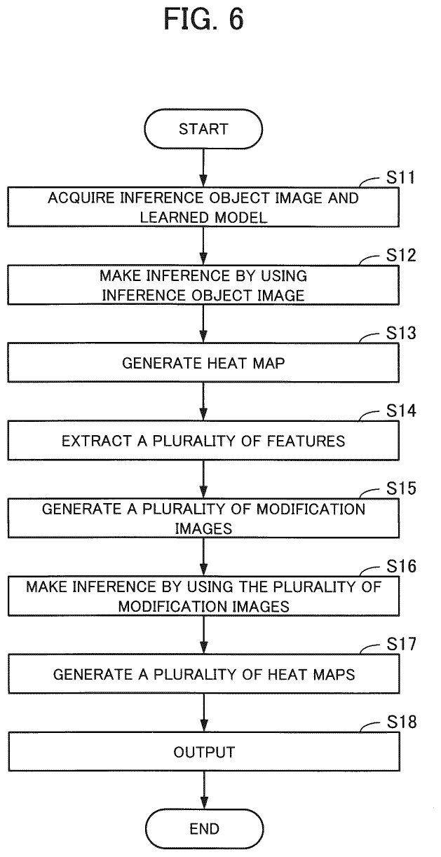

FIG. 6 is a flowchart showing an example of the process executed by the information processing device in the first embodiment.
(Step S11) The acquisition unit 120 acquires the inference object image and the learned model.
(Step S12) The inference unit 130 makes the inference by using the inference object image and the learned model.
(Step S13) The generation unit 140 generates a heat map by using the inference result.
(Step S14) The extraction unit 150 extracts a plurality of features based on the region corresponding to the part as the basis of the inference result indicated by the heat map. Incidentally, this region is a region in the inference object image.
(Step S15) The generation unit 140 generates a plurality of modification images based on the plurality of features.
(Step S16) The inference unit 130 makes the inference by using the plurality of modification images and the learned model.
(Step S17) The generation unit 140 generates a plurality of heat maps by using a plurality of inference results.
(Step S18) The output unit 160 outputs the inference object image, the heat map corresponding to the inference object image, the plurality of modification images, and the plurality of heat maps corresponding to the plurality of modification images. Incidentally, it is permissible even if the output unit 160 does not output the inference object image and the heat map corresponding to the inference object image.

According to the first embodiment, the information processing device 100 outputs the plurality of modification images and the plurality of heat maps corresponding to the plurality of modification images. The user can understand the inference basis by viewing the plurality of modification images and the plurality of heat maps. Therefore, the plurality of modification images and the plurality of heat maps are data that enable the user to understand the inference basis. Accordingly, the information processing device 100 is capable of outputting data that enable the user to understand the inference basis.

### Second Embodiment

Next, a second embodiment will be described below. In the second embodiment, the description will be given mainly of features different from those in the first embodiment. In the second embodiment, the description is omitted for features in common with the first embodiment.

In the second embodiment, a description will be given of a case where the information processing device 100 outputs inference basis information. The inference basis information is generated based on the inference object image, the heat map corresponding to the inference object image, the plurality of modification images, and the plurality of heat maps. The user can understand the inference basis by viewing the inference basis information. Therefore, the inference basis information is data that enable the user to understand the inference basis. The case where the information processing device 100 outputs the inference basis information will be described below.

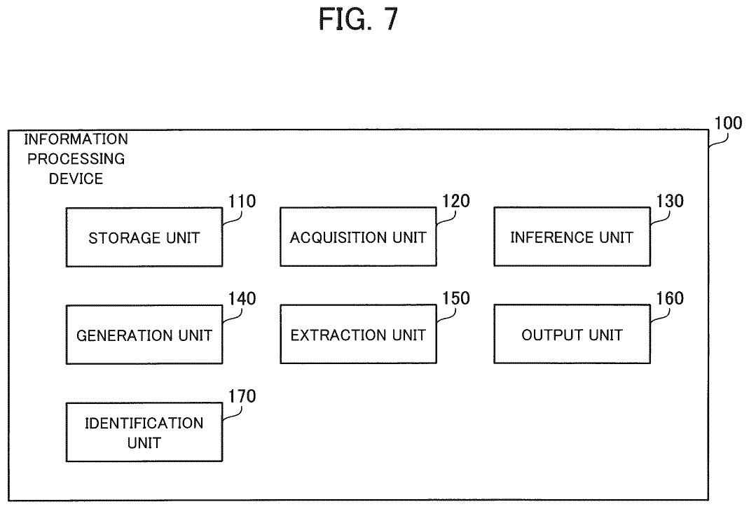

FIG. 7 is a block diagram showing functions of the information processing device in the second embodiment. The information processing device 100 further includes an identification unit 170. Part or the whole of the identification unit 170 may be implemented by processing circuitry. Further, part or the whole of the identification unit 170 may be implemented as modules of a program executed by the processor 101.

The function of the identification unit 170 will be described later.

Next, a process executed in the second embodiment will be described below by using a drawing.

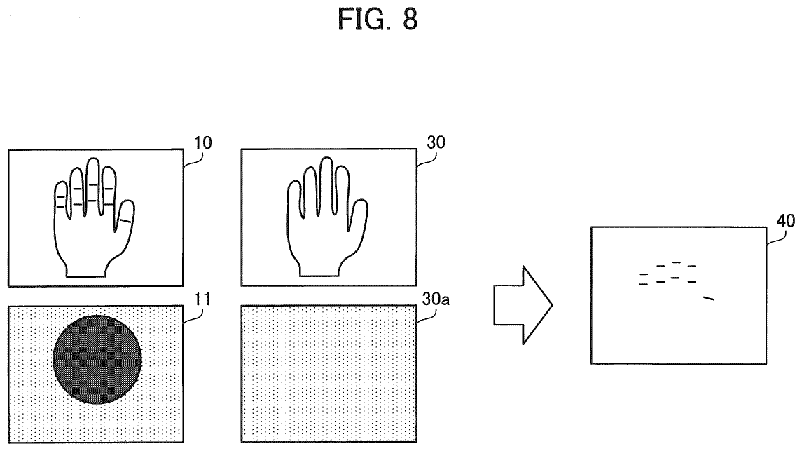

FIG. 8 is a diagram showing a concrete example of a generation process in the second embodiment. FIG. 8 indicates a modification image 30 and a heat map 30a corresponding to the modification image 30.

The identification unit 170 identifies a heat map having the greatest difference from the heat map 11 corresponding to the inference object image 10 out of the plurality of heat maps corresponding to the plurality of modification images. By this, the heat map 30a is identified.

The generation unit 140 generates an image 40 indicating the inference basis based on the difference between the inference object image 10 and the modification image 30 corresponding to the heat map 30a. Incidentally, the image 40 is referred to also as the inference basis information.

The output unit 160 outputs the inference object image, the heat map corresponding to the inference object image, the plurality of modification images, the plurality of heat maps corresponding to the plurality of modification images, and the image 40. It is also possible for the output unit 160 to output the image 40 alone.

Next, a process executed by the information processing device 100 will be described below by using a flowchart.

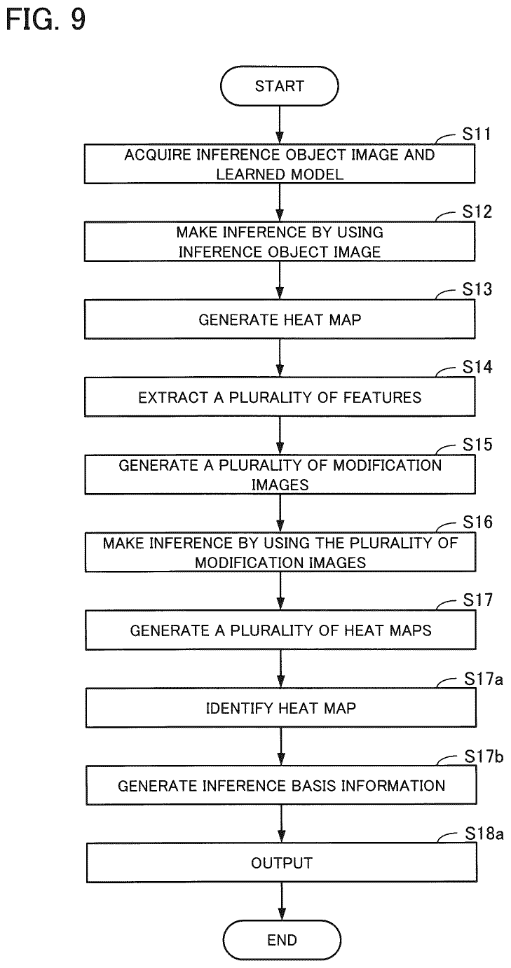

FIG. 9 is a flowchart showing an example of the process executed by the information processing device in the second embodiment. The process in FIG. 9 differs from the process in FIG. 6 in that steps S17a, S17b and S18a are executed. Thus, the steps S17a, S17b and S18a in FIG. 9 will be described below. Then, the description will be omitted for processing other than the steps S17a, S17b and S18a.
(Step S17a) The identification unit 170 identifies a heat map having the greatest difference from the heat map corresponding to the inference object image out of the plurality of heat maps corresponding to the plurality of modification images.
(Step S17b) The generation unit 140 generates an image indicating the inference basis as the inference basis information based on the difference between the inference object image and the modification image corresponding to the identified heat map.
(Step S18a) The output unit 160 outputs the inference object image, the heat map corresponding to the inference object image, the plurality of modification images, the plurality of heat maps corresponding to the plurality of modification images, and the inference basis information.

According to the second embodiment, the information processing device 100 outputs the image 40. Therefore, the user can easily identify the inference basis by viewing the image 40. Accordingly, the information processing device 100 is capable of reducing an analysis load on the user.

### First Modification of Second Embodiment

The case where one inference basis is outputted has been described above. In a first modification of the second embodiment, a description will be given of a case where a plurality of inference bases is outputted. A process executed in the first modification of the second embodiment will be described below by using a drawing.

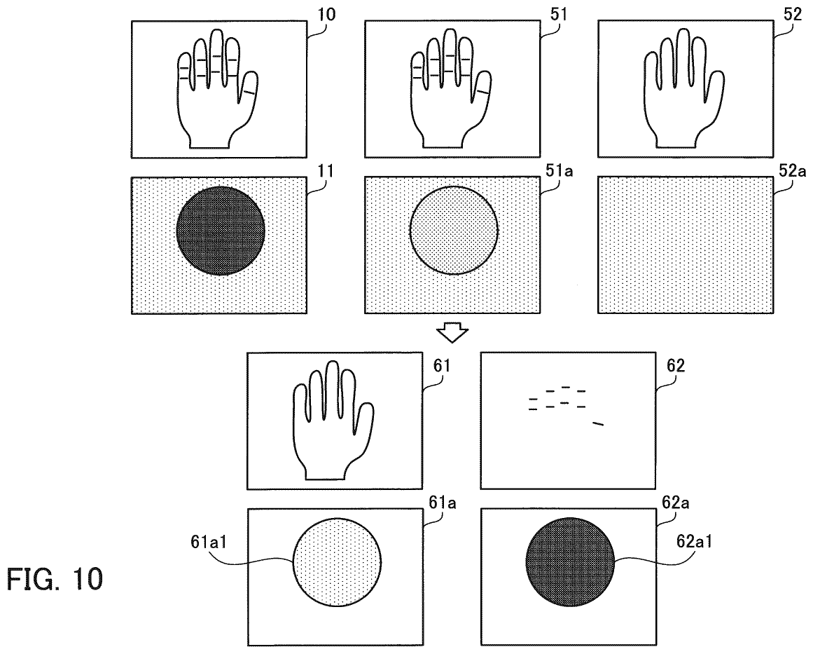

FIG. 10 is a diagram showing a concrete example of a generation process in the first modification of the second embodiment. FIG. 10 indicates a modification image 51 and a heat map 51a corresponding to the modification image 51. Further, FIG. 10 indicates a modification image 52 and a heat map 52a corresponding to the modification image 52.

The identification unit 170 identifies a plurality of heat maps having a difference from the heat map 11 corresponding to the inference object image 10 out of the plurality of heat maps corresponding to the plurality of modification images. By this, the heat maps 51a and 52a are identified. Incidentally, the plurality of heat maps is referred to also as a plurality of identified heat maps.

The generation unit 140 generates a plurality of images based on the differences between the inference object image 10 and a plurality of modification images corresponding to the plurality of identified heat maps. For example, the generation unit 140 generates an image 61 indicating the inference basis based on the difference between the inference object image 10 and the modification image 51 corresponding to the heat map 51a. Further, for example, the generation unit 140 generates an image 62 indicating the inference basis based on the difference between the inference object image 10 and the modification image 52 corresponding to the heat map 52a. Incidentally, the images 61 and 62 are referred to also as the inference basis information.

Further, the generation unit 140 generates a plurality of images based on the differences between the heat map 11 corresponding to the inference object image 10 and the plurality of identified heat maps. For example, the generation unit 140 generates an image 61a based on the difference between the heat map 11 and the heat map 51a. Further, for example, the generation unit 140 generates an image 62a based on the difference between the heat map 11 and the heat map 52a. Incidentally, the plurality of images is referred to also as a plurality of inference basis level images.

The output unit 160 outputs the inference basis information. For example, the output unit 160 outputs the images 61 and 62. The user can recognize that there exist a plurality of inference bases by viewing the images 61 and 62.

Further, the output unit 160 outputs the plurality of inference basis level images. For example, the output unit 160 outputs the images 61a and 62a. The user can recognize the levels of the inference bases by viewing the images 61a and 62a. For example, a region 61a1 in the image 61a is a region indicating an inference basis. A region 62a1 in the image 62a is a region indicating an inference basis. The color of the region 62a1 is denser than the color of the region 61a1. Therefore, the user can recognize that the inference basis indicated by the image 62 is stronger than the inference basis indicated by the image 61 in terms of the inference basis level.

### Second Modification of Second Embodiment

A process executed in a second modification of the second embodiment will be described below by using a drawing.

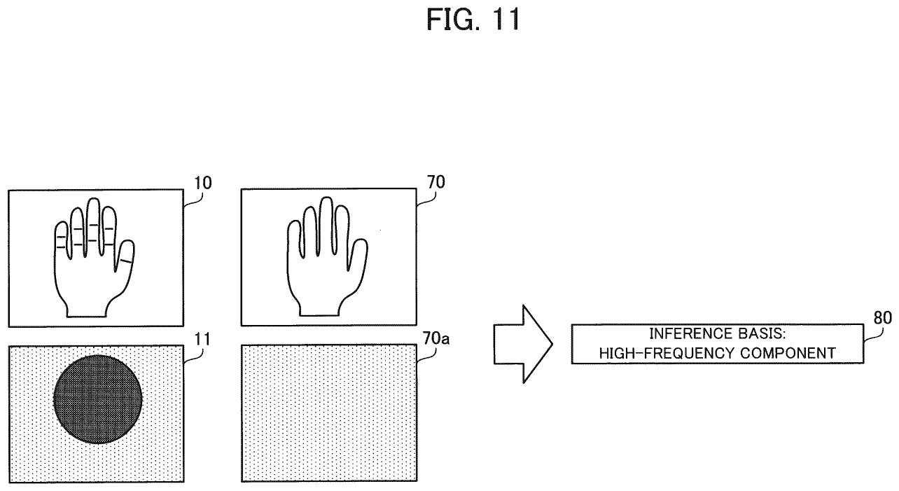

FIG. 11 is a diagram showing a concrete example of a generation process in the second modification of the second embodiment. FIG. 11 indicates a modification image 70 and a heat map 70a corresponding to the modification image 70.

The identification unit 170 identifies a heat map having the greatest difference from the heat map 11 corresponding to the inference object image 10 out of the plurality of heat maps corresponding to the plurality of modification images. By this, the heat map 70a is identified.

The generation unit 140 generates a feature, that was modified when generating the modification image 70 corresponding to the heat map 70a, as textual information 80. For example, the modification image 70 is an image in which the high-frequency component as the feature has been removed. Therefore, the generation unit 140 generates the textual information 80 indicating the high-frequency component. Incidentally, the textual information 80 is referred to also as the inference basis information.

The output unit 160 outputs the textual information 80. Accordingly, the user can intuitively recognize the inference basis.

Further, when a plurality of inference bases is identified as in the first modification of the second embodiment, the information processing device 100 may output a plurality of pieces of textual information. Specifically, the generation unit 140 generates a plurality of features, that were modified when generating the plurality of modification images corresponding to the plurality of heat maps, as the inference basis information being the plurality of pieces of textual information. This process will be described concretely below by using FIG. 10. The generation unit 140 generates a plurality of features, that were modified when generating the modification images 51 and 52 corresponding to the heat maps 51a and 52a, as the plurality of pieces of textual information. The output unit 160 outputs the plurality of pieces of textual information as the inference basis information.

Accordingly, the user can intuitively recognize the plurality of inference bases.

### Third Embodiment

The first and second embodiments have been described above in regard to cases where each embodiment is implemented by one information processing device. Each of the first and second embodiments may also be implemented by an information processing system. An example of the information processing system will be shown below.

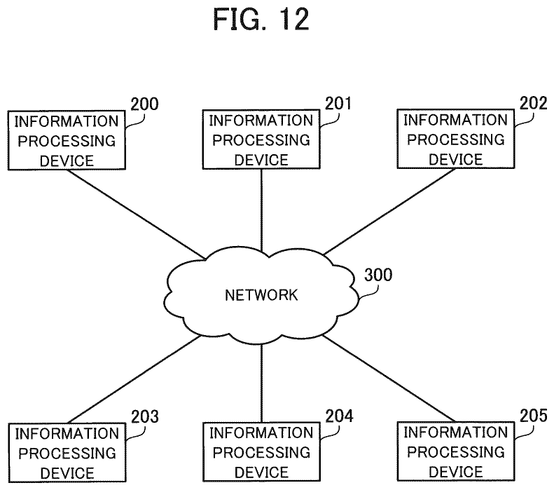

FIG. 12 is a diagram showing an information processing system in a third embodiment. The information processing system includes a plurality of information processing devices. For example, the information processing system includes information processing devices 200 to 205. The information processing devices 200 to 205 execute communication via a network 300. The network 300 is a wired network or a wireless network. The functions of the information processing device 100 may be implemented by a plurality of information processing devices. For example, the functions of the information processing device 100 may be implemented by the information processing devices 200 to 205.

Accordingly, the information processing system is capable of implementing the first and second embodiments.

Features in the embodiments described above can be appropriately combined with each other.

### DESCRIPTION OF REFERENCE CHARACTERS

10: inference object image, 10a: region, 11: heat map, 11a: range, 21-26: modification image, 21a-26a: heat map, 30: modification image, 30a: heat map, 40: image, 51, 52: modification image, 51a, 52a: heat map, 61, 62: image, 61a, 62a: image, 61a1: region, 62a1: region, 70: modification image, 70a: heat map, 80: textual information, 100: information processing device, 101: processor, 102: volatile storage device, 103: nonvolatile storage device, 110: storage unit, 120: acquisition unit, 130: inference unit, 140: generation unit, 150: extraction unit, 160: output unit, 170: identification unit, 200-205: information processing device, 300: network

What is claimed is:

1. An information processing device comprising:
acquiring circuitry to acquire an inference object image and a learned model;
inferring circuitry to make an inference by using the inference object image and the learned model;
generating circuitry to generate a heat map that indicates a basis of an inference result by using the inference result;
extracting circuitry to extract a plurality of features based on a region in the inference object image, the region being a region corresponding to a part as the basis of the inference result indicated by the heat map; and
outputting circuitry, wherein
when the plurality of features has been extracted, the generating circuitry generates a plurality of modification images by making a modification in regard to each of the features by using the inference object image,
when the plurality of modification images has been generated, the inferring circuitry makes the inference by using the plurality of modification images and the learned model,
when the inference has been made by using the plurality of modification images and the learned model, the generating circuitry generates a plurality of heat maps by using a plurality of inference results, and
the outputting circuitry outputs the plurality of modification images and the plurality of heat maps, or inference basis information generated based on the inference object image, the heat map, the plurality of modification images and the plurality of heat maps.

2. The information processing device according to claim 1, wherein the generating circuitry generates an image in a color opposite in hue to a color as the feature as the modification image by using the inference object image.

3. The information processing device according to claim 1, wherein when the feature is a color of a peripheral part in the region, the generating circuitry generates an image in a same color as the color of the peripheral part in the region as the modification image by using the inference object image.

4. The information processing device according to claim 1, wherein the generating circuitry generates an image with lightness opposite to lightness as the feature as the modification image by using the inference object image.

5. The information processing device according to claim 1, wherein when the feature is lightness of a peripheral part in the region, the generating circuitry generates an image with lightness the same as lightness of the peripheral part in the region as the modification image by using the inference object image.

6. The information processing device according to claim 1, wherein the generating circuitry generates the modification image, in which a frequency component as the feature has been removed, by using the inference object image.

7. The information processing device according to claim 1, further comprising identifying circuitry to identify a heat map having a greatest difference from the heat map corresponding to the inference object image out of the plurality of heat maps,
wherein the generating circuitry generates an image as the inference basis information based on a difference between the inference object image and the modification image corresponding to the identified heat map.

8. The information processing device according to claim 1, further comprising identifying circuitry to identify a plurality of heat maps having a difference from the heat map corresponding to the inference object image as a plurality of identified heat maps out of the plurality of heat maps,
wherein the generating circuitry generates a plurality of images as the inference basis information based on differences between the inference object image and a plurality of modification images corresponding to the plurality of identified heat maps.

9. The information processing device according to claim 8, wherein
the generating circuitry generates a plurality of inference basis level images based on differences between the heat map corresponding to the inference object image and the plurality of identified heat maps, and
the outputting circuitry outputs the plurality of inference basis level images.

10. The information processing device according to claim 1, further comprising identifying circuitry to identify a heat map having a greatest difference from the heat map corresponding to the inference object image out of the plurality of heat maps,
wherein the generating circuitry generates a feature, that was modified when generating the modification image corresponding to the identified heat map, as the inference basis information being textual information.

11. The information processing device according to claim 1, further comprising identifying circuitry to identify a plurality of heat maps having a difference from the heat map corresponding to the inference object image as a plurality of identified heat maps out of the plurality of heat maps,
wherein the generating circuitry generates a plurality of features, that were modified when generating a plurality of modification images corresponding to the plurality of identified heat maps, as the inference basis information being a plurality of pieces of textual information.

12. An information processing system including a plurality of information processing devices, comprising:
acquiring circuitry to acquire an inference object image and a learned model;
inferring circuitry to make an inference by using the inference object image and the learned model;
generating circuitry to generate a heat map that indicates a basis of an inference result by using the inference result;
extracting circuitry to extract a plurality of features based on a region in the inference object image, the region being a region corresponding to a part as the basis of the inference result indicated by the heat map; and
outputting circuitry, wherein
when the plurality of features has been extracted, the generating circuitry generates a plurality of modification images by making a modification in regard to each of the features by using the inference object image,
when the plurality of modification images has been generated, the inferring circuitry makes the inference by using the plurality of modification images and the learned model,
when the inference has been made by using the plurality of modification images and the learned model, the generating circuitry generates a plurality of heat maps by using a plurality of inference results, and
the outputting circuitry outputs the plurality of modification images and the plurality of heat maps, or inference basis information generated based on the inference object image, the heat map, the plurality of modification images and the plurality of heat maps.

13. An output method performed by an information processing device, the output method comprising:
acquiring an inference object image and a learned model;
making an inference by using the inference object image and the learned model;
generating a heat map that indicates a basis of an inference result by using the inference result;
extracting a plurality of features based on a region in the inference object image, the region being a region corresponding to a part as the basis of the inference result indicated by the heat map;
generating a plurality of modification images by making a modification in regard to each of the features by using the inference object image;
making the inference by using the plurality of modification images and the learned model;
generating a plurality of heat maps by using a plurality of inference results; and
outputting the plurality of modification images and the plurality of heat maps, or inference basis information generated based on the inference object image, the heat map, the plurality of modification images and the plurality of heat maps.

14. An information processing device comprising:
a processor to execute a program; and
a memory to store the program which, when executed by the processor, performs processes of,
acquiring an inference object image and a learned model,
making an inference by using the inference object image and the learned model,
generating a heat map that indicates a basis of an inference result by using the inference result,
extracting a plurality of features based on a region in the inference object image, the region being a region corresponding to a part as the basis of the inference result indicated by the heat map,
generating a plurality of modification images by making a modification in regard to each of the features by using the inference object image,
making the inference by using the plurality of modification images and the learned model,
generating a plurality of heat maps by using a plurality of inference results, and
outputting the plurality of modification images and the plurality of heat maps, or inference basis information generated based on the inference object image, the heat map, the plurality of modification images and the plurality of heat maps.
